(19) United States
(12) Patent Application Publication
(10) Pub. No.: US 2008/0114632 A1
(43) Pub. Date: May 15, 2008

(54) SYSTEM AND METHOD FOR USING OPTICAL STORAGE MEDIA ANALYSIS

(75) Inventors: Charles Calvin Brooks Partee, Lyons, CO (US); John Clarence Meyer, Firestone, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: CheckFlix, Inc., Denver, CO (US)

(21) Appl. No.: 11/937,965

(22) Filed: Nov. 9, 2007

Related U.S. Application Data
(60) Provisional application No. 60/865,197, filed on Nov. 10, 2006.

(51) Int. Cl. G06Q 10/00; G11B 7/00

(52) U.S. Cl. 705/7; 705/1; 369/53.2

(57) ABSTRACT

Aspects of the present invention involve an optical storage media inventory system and methods that leverages the capabilities of an optical storage media characterization device to direct repair of the optical storage media if it is damaged, to assess pecuniary penalties to a rental customer responsible for the damage or take other action. In one example, an optical storage media, such as a DVD with movie data recorded thereon, is processed in a optical storage media characterization device to render a damage level. Based on the damage level, repair may be undertaken, the customer may be charge, or any combination of various actions may be taken.

### CROSS-REFERENCE TO RELATED APPLICATIONS

This application is a non-provisional patent application claiming priority under 35 U.S.C. § 119(e) to provisional patent application No. 60/865,197 titled “Method for Using Optical Storage Media Analysis” filed on Nov. 10, 2006, and this application is related to non-provisional patent application Ser. No. 11/558,759 titled “Apparatus and Method for Analysis of Optical Storage Media” filed on Nov. 10, 2006, both of which are hereby incorporated by reference herein.

### FIELD OF THE INVENTION

Aspects of the invention involve methods for implementing an apparatus that measures the quality of an optical storage medium (“OSM”) into an OSM rental, sale, or resale business, such as a DVD rental, sale, or resale business or video game rental, sale, or resale business, and using the analysis provided by OSM.

### BACKGROUND

The information storage industry is driven by market demands to increase continually the capacity and performance of devices for storing information. One of the needs is distribution of information (spatial communication) to various locations and retention of information (temporal communication) to be accessed at a later time. One popular application for information storage is storage of video information, such as movies, TV shows, and home videos. Another popular application is storage of music information. Yet another application is the storage and distribution of software to end-users. Driven by and reflecting this market demand, a variety of storage formats have been introduced into the market to fill various needs.

There are numerous methods of storing information, such as through printed matter (e.g., books and magazines), semiconductor-based RAM and FLASH memories, magnetic-based MRAM or bubble memories, magnetic-based Winchester-type disk drives, optical storage using phase-change, prefabricated or “burned” media, and holographic storage, among others. There are certain advantages and disadvantages of each type and, over time, certain types of storage tend to dominate certain applications. For music, video, and software distribution, as well as others, optical storage media (“OSM”) are popular methods of storing data.

The compact disc (“CD”), a type of OSM, was introduced in the 1970s and soon became a popular method for storage and distribution of music information due to certain advantages it held over the then state-of-the-art (cassette tapes and LP records). The CD medium was also adopted for storage and distribution of computer software due to certain advantages it held over the then state-of-the-art (floppy disks). Further advances in media and CD recorder/player technology, types of readback devices, allowed companies and consumers to record their own CDs, using several different formats available, to store information of many types from music and video, to pictures and images, to software and data.

The DVD (sometimes styled as Digital Video Disc or Digital Versatile Disc although the exact expansion (if any at all) of the acronym is not generally agreed on), another type of OSM, was introduced in the 1990s and quickly became popular for distribution of pre-recorded video information, such as movies and extra features. The DVD format also allows for storage and distribution of software and other forms of data. Further advances in DVD media and DVD recorder/player technology, another type of readback device, allowed companies and consumers to record their own DVDs to store information of many types from music and video, to pictures and images, to software and data.

New technologies are now emerging to store even more data on an optical storage medium. For example, two new competing formats, popularly referred to as Blu-ray and HD-DVD store over 15 Gbytes per disc. This enables the storage and distribution of an HDTV-format movie on a single disc. Information storage using the principles of holography is also under development. Other improvements and formats will doubtless be introduced from time to time in this competitive market.

In general conceptual terms, the physical structure and operational principles of most optical storage methods is similar. FIG. 1 is a partial side section view of an OSM 10. The binary data is encoded and recorded onto the disc by differences in the height of the recording layer (generally called “lands” 12 and “pits” 14) or changes in the phase of the material or other methods. The OSM includes a substrate 16 of acrylic or other material. In a phase-change-based OSM, a layer of the appropriate material for phase recording is included in the substrate. In an OSM that uses difference in height, the pits and lands are encoded in the substrate. A protective coating 18, such as a polycarbonate, is applied over the substrate. The coating is substantially optically transparent, at least for the wavelength of the laser used to read the data. An aluminized layer may also be applied to the substrate over the pits and lands. The aluminized layer improves reflection of a laser from the pits and lands. A label 22 may be provided on the substrate 16.

The laser is used to scan the disc and read back the data by detecting the variation in the reflected light. The data is stored in microscopic grooves running in a spiral around the disc. The data playback device uses laser beams to scan these grooves, where minuscule reflective bumps (the lands) and non-reflective holes (the pits) aligned along the grooves represent the zeros and ones of digital information.

In various types of OSM and as mentioned above, the data layer may be protected by a protective coating 18 or surface 18. In CDs and DVDs, the protective coating is typically a polycarbonate material. One of the significant problems that current users of optical storage media face is damage to the OSM protective surface. Damage in the form of scratches, dents, nicks, smudges, etc. can scatter or change the behavior of the reflected or transmitted light to the point that the data can no longer be read. OSM error correction coding (“ECC”) which involves ways to detect errors in data read from the OSM and correct those errors, can handle errors of a certain size, depending on the readback device, but errors larger than that threshold cause the readback device to be unable to play through the damage. In DVD players, this can be manifested as skipping, freezing, or an inability to even recognize the DVD's presence. In CD players, it can manifest itself as a high-pitched and annoying click, skipping, freezing, or an inability to even recognize the CD's presence. The frequency of this damage has been growing year over year as the rapid market penetration of OSM has reached relatively unsophisticated consumers (e.g. children) who do not treat the fragile protective surface with proper care.

Due to the popularity of CDs, DVDs, and other OSM types among consumers, businesses that rent and sell (both new and used) OSM are numerous. These include stores that rent DVDs (such as Blockbuster™ or Netflix™), that sell DVDs and CDs (Blockbuster™, Warehouse Music™), that buy and resell used OSM (GameStop™). Others (such as PeerFlix™ or Ebay™) facilitate the trading by bringing a seller and a purchaser together. In recent years, automated methods for dispensing OSM have been introduced (Redbox™), generally but not exclusively in the form of a kiosk. Some of these automated kiosks accept used DVDs in trade and sell used and new DVDs (ePlay™).

It is advantageous for companies selling, buying, or renting OSMs to identify OSMs that are damaged to prevent returns and prevent dissatisfied customers. It is further advantageous for such companies to identify when the OSM was damaged. There are currently three common ways to do this: first, perform a visual inspection of the surface of the OSM, which only finds the most significant scratches or breakage points, is not quantitative, and is clearly inadequate; second, read back the data in its entirety (for a DVD movie, play back the movie and explore all the supplemental menus on the DVD while a person watches the monitor; for a video game, play through all the levels and options), which is unrealistic and time-consuming; third, discover media problems when customers complain. This latter technique is the one that many DVD rental businesses use. This approach costs the rental store in direct costs of replacing the DVD, but also in loss of customer good will.

The internet-based mail-delivery stores, such as Netflix™, also use the customer as their means to detect damaged OSMs. Typically, there is a check-off box on the return envelope that allows the customer to inform the company that the DVD is damaged and whether or not they want another copy of that movie to try to watch it again. Also common is the option to contact the company via the internet or telephone to have another disc mailed. When some internet-order, mail-delivery businesses are told a disc is bad, an operator in their receiving department actually loads the disc into a DVD player to see if the menus will play. They then may flip through a few scenes in the movie. This is time-consuming, inefficient, and the resultant decision is inconsistent and non-reproducible across the company, as the result depends solely on the operator.

A technique that substantially reduces or eliminates including a damaged OSM in the supply chain and thus nearly guarantees to the consumer that the rental DVD will play properly would become a significant differentiating advantage for rental businesses.

Many of these businesses that sell, resell, or rent OSM, have methods or devices for repairing some level of damage to an OSM. One of the frequent difficulties is knowing whether their repair method will work or, in cases where different amounts of repair are possible and what repair methods to use. In this application, all these businesses are referred to as OSM-based or OSM businesses.

As will be recognized from the discussion below, these and other problems in the art are addressed by various systems and methods conforming to aspects of the present invention.

### SUMMARY

In accordance with aspects of the invention, disclosed herein are methods for using an OSM characterization device (“OCD”) in these businesses to advantage that are new and heretofore unused. Methods for utilizing this equipment in businesses that rent, sell, or resell OSM are disclosed. One particular OCD device can rapidly characterize the surface of the protective layer of an OCD to determine whether the OSM can adequately be read by an OSM device. Other methods read back the data or portions of the data from the OSM and report errors found or make an estimation of the likelihood of errors based on the sample of the data. Regardless of the details of the method used, these OCD devices may provide, along with other information, an estimate of the likelihood that an OSM will play, and on what proportion of DVD players, or an estimate of the amount of damage to the surface or data. These and other advantages are set forth in more detail below.

One particular aspect of the invention involves a method for assessing an optical storage media and directing action based on the assessment. The method includes the operation of analyzing an optical storage media to provide a damage level indication and identifying an action based on the damage level indication.

Another particular aspect of the invention involves a method for assessing an optical storage media and directing action based on the assessment. The method includes, in conjunction with providing a optical storage media to a customer, the operations of analyzing the optical storage media to provide a damage level indication; and updating a data file to include a customer identification, an optical storage media identifier of the optical storage media provided to the customer and the damage level indication. The method further includes, in conjunction with return of the optical storage media by the customer, the operations of analyzing the optical storage media to provide a second damage level indication; updating the data file to include the second damage level indication; and identifying an action as a function of the first damage level and the second damage level.

Another particular aspect of the invention involves an optical storage media inventory system that includes an optical storage media characterization device configured to receive an optical storage media and provide a damage level assessment based on an optical assessment of the optical storage media. The system further includes an inventory application coupled with the optical storage media configured to link a customer with the optical storage media, track the damage level assessment of the optical storage media at a first time and a second time, and provide an action indication as a function of tracking the damage level assessment between the first time and the second time.

Before explaining the disclosed embodiments in detail, it is to be understood that the invention is not limited in its application to the details of the particular arrangement shown, because the invention is capable of other embodiments. Moreover, aspects of the invention may be set forth in different combinations and arrangements to define inventions unique in their own right. Also, the terminology used herein is for the purpose of description and not of limitation.

### BRIEF DESCRIPTION OF THE DRAWINGS

FIG. 1 is a representative section of an optical storage media or OSM;

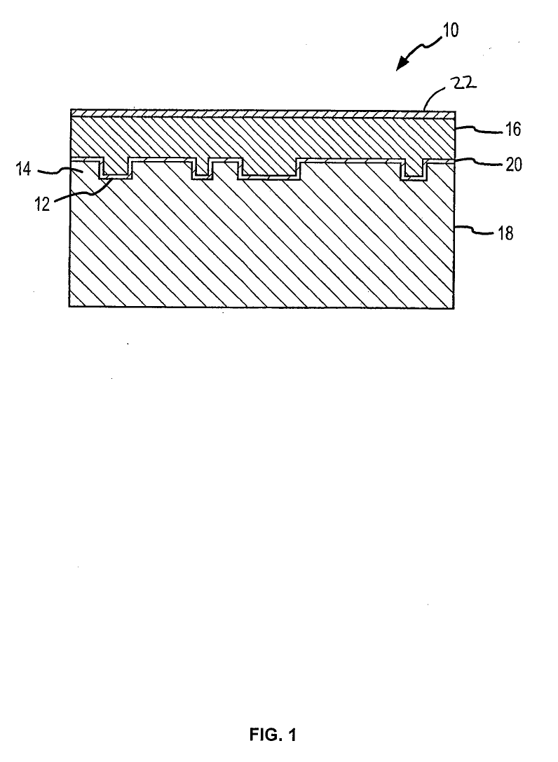

FIG. 2 is a system diagram of one implementation of a optical storage media inventory system conforming to aspects of the present invention;

FIG. 3 is a flowchart illustrating a method for assessing an optical storage media and taking action in accordance with the assessment, the method conforming to aspects of the present invention; and

FIG. 4 is a flowchart illustrating a second method for assessing an optical storage media and taking action in accordance with the assessment, the method conforming to aspects of the present invention.

### DETAILED DESCRIPTION OF EMBODIMENTS

Embodiments and aspects of the invention involve systems and methods of using an optical storage media characterization device or “OCD” in an OSM based business to improve customer satisfaction, reduce costs, improve efficiency, and reap other benefits. One example of an OCD device suitable for use in various implementation set forth herein is described in patent application Ser. No. 11/558,759 titled “Apparatus and Method for Analysis of Optical Storage Media.” For example, in various possible arrangements an OCD may be deployed to determine the likelihood of reading an OSM, to determine the frequency of defects, to determine the types of defects present in an OSM, to determine the severity (depth, height, etc.) of some number of the largest defects, and to determine the amount of repair required to meet a certain standard, including a minimum playability standard. In the recited examples, the assessments or determinations chosen depends on the capability of the OCD and the needs of the OSM-based business, and may be used alone or in any number of possible combinations. Based on any one or some combination of these determinations, the system may identify the OSM for repair, removal from inventory, may direct a debit or other charge of a consumer account, and otherwise update various records associated with the OSM, the customer, or the like.

In one particular embodiment, an OSD device or devices generate a “damage score” or “damage level” of particular OSMs. The damage score may be related to a likelihood of the OSM playing properly. For the sake of illustration but not limitation, the damage score can be limited to a range of 0 to 10 and the damage score may be assigned so that scores of 0 to 3 will play in nearly all optical readback devices, scores of 4 to 5 will play in most optical readback devices, and 5 and above are unlikely to play. In another embodiment, the damage score can reflect the amount of physical damage that has occurred to the OSM regardless of whether that damage is likely to prevent the disc from playing.

At a customer return point and/or a point of output to a customer, one or more OSM devices may be deployed and operably coupled with an inventory application that identifies customers, various rental history data and customer identification information. When an OSM is rented or returned, the OSM is loaded in the OCD and analyzed to generate a damage score. The damage score can thus be recorded and tracked for each OSM as it is rented and returned. On the return side, in cases where the damage score increased appreciably (say, from 0 to 5), even though the OSM will still play, the customer application can be configured to notify the customer in whose possession the OSM suffered this change of the damage or automatically apply a damage charge to the customer's account.

In another arrangement, on the return side, an OSM rental business, such as a DVD rental business, may use the OCD to inspect discs as they are returned from a customer. Discs that have a high likelihood of having errors can be discarded or repaired, and the inventory application automatically updated to indicate a replacement is needed or to track the repair. In the event the particular OSM title is not frequently rented, the application may be configured to not indicate a replacement is necessary. OSMs that have a low likelihood of having errors can be returned to inventory for another rental.

In another arrangement, an OSM rental business, such as a DVD rental business, may use the OCD to inspect OSMs before they are rented to a customer. For example, an OCD device may be operably coupled with a checkout device at a checkout counter, the checkout device providing an input and display platform for the customer/inventory application. OSMs that have a likelihood, in excess of that store's policy, of having errors, can be identified before the customer receives it. In the case where this is done at the counter as the OSM is being rented, this adds a level of assurance to the customer that the OSM will play properly. Additionally, the outgoing damage level can be recorded and compared to the return side damage level resulting in possible notification, charges or other action, as set forth above.

The amount of damage on an OSM can be kept track of throughout its history in a database linked to the customer/inventory application, which can include a simple log book or sophisticated computerized tracking system or other method. This information can allow the business to determine how much degradation or damage was done to the OSM in the interval between testing. In one embodiment wherein a damage score from 0-10 is recorded, the customer who damages the OSM sufficiently that it can not play can be identified. In another embodiment where a damage score (say, from 0 to 10) is recorded, in cases where the damage score increased appreciably (say, from 1 to 4), even though the OSM can still be read back, the customer in whose possession the OSM suffered this change can be identified. Depending on the needs of the store, the customer can be informed of the damage, informed of proper care, billed for the damage, or lose their rights to rent OSM, or other steps as the store prefers.

As mentioned above, the OCD may be connected directly to the point of sale terminal at a store. If the OSM does not meet the proper standard, the OSM can not be purchased, sold, or rented. This information can also be recorded in a database for use as described above.

Since the OCD offers a method for determining damage, the customer/inventory or other application may be arranged so that the store can offer rental insurance to the customer and track the insurance so that regardless of the damage done, the customer is not liable. This can be done in conjunction with a program that bills customers for damage to OSM. This OCD-based insurance approach provides an additional revenue source for the store.

In the competitive OSM rental, sale, and resale business, differentiating factors are critical to success. Currently, businesses do not check OSMs before they leave the store. With an OCD-based method that guarantees or nearly guarantees that the OSM will play properly, advertising that they screen all OSM for quality may help draw in customers.

A database can be kept of customer responses. If the OCD predicts that the OSM will play, but the customer says it does not, the threshold for not renting a particular OSM can be lowered for that customer.

For purchasing used OSMs, the OCD can be used to assure the purchaser that the OSM will play and therefore is able to be resold with confidence. In an additional embodiment, the information from the OCD can be used as a factor in the price. This provides an objective method for assessing damage to reduce conflict with the user. These embodiments can be enjoyed by storefront, internet-based mail order, and kiosk-based OSM businesses.

Many OSM businesses have methods and/or devices that can repair certain types of damage on OSM as discussed above. In large stores, many different employees may, at one time or another, be responsible for repairing damaged OSM. In cases where multiple methods are used (such as wiping the OSM with a cleaning fluid versus polishing it with an abrasive) or where the repairing device has multiple programs for different types and thresholds of damage, it is difficult for the OSM business to have a consistent approach with multiple operators and no quantitative method for determining the nature of the damage.

Equipment used for repairing damaged OSMs generally uses different repair methods, including different time spent performing the repair method, depending on the nature of the damage. For example, for an OSM with fingerprints, a cleaning solution and a minimally abrasive pad may be used to clean the OSM. For an OSM with light scratches, a lightly abrasive material and/or lapping slurry may be used to remove a small amount of the protective layer until the thickness of the protective layer has been reduced sufficiently that the scratch is reduced in depth to the desired amount. In some cases, a minimally abrasive material is then used to polish the final surface. For an OSM with deep scratches, a more abrasive material and/or lapping slurry may be firstly used to rapidly remove the protective layer to a certain depth, followed by a lightly abrasive pad. In some cases, a minimally abrasive material is then used to polish the final surface. Often the different types of methods are codified into fixed programs that the user can select. In some cases, the different types of methods may have variable parameters, such as the time of each abrasive or polishing operation that the user can select. It is desirable to select the program that will repair the defect to a certain minimum level of playability, but not remove more material than is necessary to maximize the number of repairs that can be performed on a given disc before the protective material is entirely or substantially removed.

In OSM-based businesses that utilize repair systems, the decision on which of the methods or parameters is suitable for a given defective disc is a recurring problem. Typically, the decision is made by visual inspection. The several disadvantages in this approach are that different people may judge the required repair differently, that they may judge the required repair incorrectly, leading to an over-aggressive repair or an incomplete repair, and the recurring cost of training employees to make said distinctions. A particular OCD that measures the amount of damage, such as the one described in the herein incorporated patent application can be used to quantify the nature of the damage. The OCD may then be configured to measure the disc and display the proper method or program via a display method such as LCD readout or display screen or, even more advantageously, can communicate directly with the repair equipment to set the proper program to achieve a certain level of repair. After the repair, the OCD can be used again to verify that the repair or cleaning was successful.

In one embodiment, the OCD can be integrated into an automated repair system that takes a stack of unsorted OSMs, the OCD module measures each disc and determines the appropriate repair program, then the repair module executes the given program, and then passes the OSM to the output. The OCD may also determine which discs do not need repair and cause the automated repair system to pass these OSMs directly to the output. In another embodiment, the quality of the repair can be checked by returning the repaired OSM to the OCD to ensure that a minimum level of playability was achieved. In this way, a large number of discs can be efficiently and accurately repaired without operator intervention. This is also advantageous for unattended kiosk-based OSM businesses.

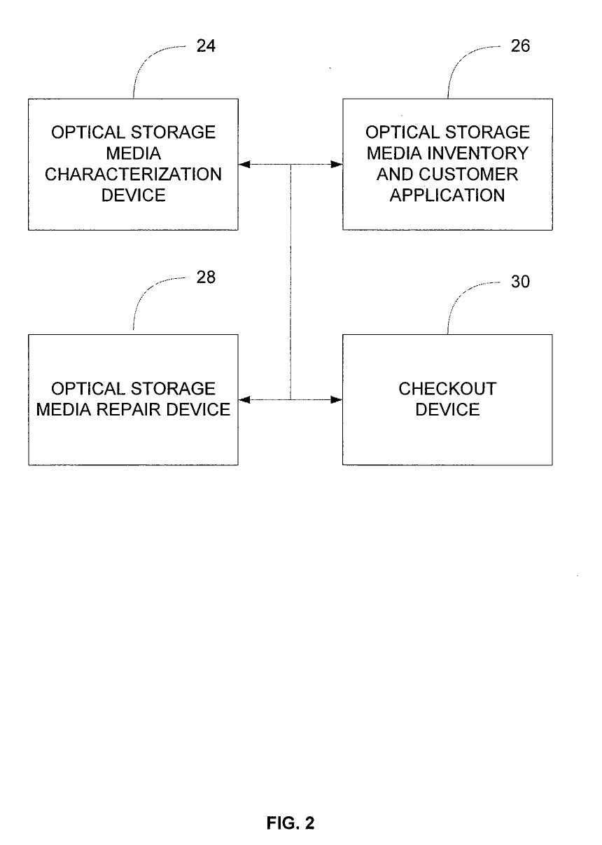

FIG. 2 is a system block diagram illustrating one possible implementation conforming with aspects of the present invention. The system involves an OCD device 24 coupled or otherwise in communication with an inventory application 26. The OCD device is configured to analyze a CD, DVD, or other OSM and provide some form of indicator (e.g., a damage level, of the ability of data stored on the OSM to be read by a CD player, DVD player, etc. Inventory, customer and other information and processes of the OSM business is set out in the inventory application. Moreover, the OSM assessment output may be coupled with the inventory application so that the information from the OSM assessment may be tracked and used in further processes, discussed in further detail below. Whether in a consumer outlet, in a warehouse, or the like, the system may further include a optical storage media repair device 28 coupled with the OCD device and/or the inventory application. The repair device may be configured to conduct some form of repair, whether automated or requiring some user interaction, based on the assessment from the OCD device, and provide the results to the inventory application. In a retail outlet, the system may further include a checkout device 30 configured to perform or facilitate various transactions or other actions discussed herein.

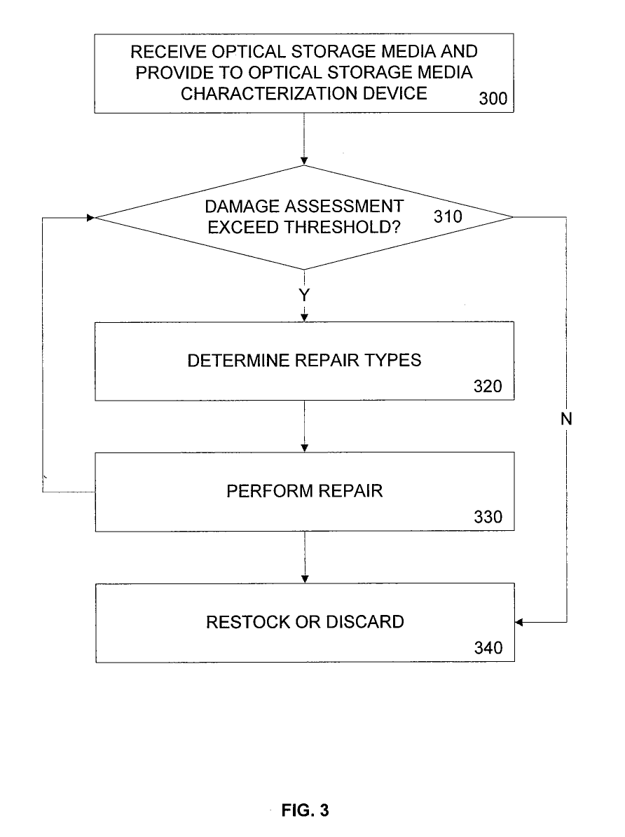

FIG. 3 is a flow diagram illustrating one computerized method for employing an OCD device 24 to communicate with, or be integrated with, an automated repair device 28. Whether receiving return rentals at a retail outlet, or in a mail/internet warehouse based business, optical storage media is received for processing by the OCD device (operation 300). In this implementation, one or more OSMs are processed in an OCD device which provides a damage score output. The damage score is compared to a threshold to determine if repair is required (operation 310). For example, if the damage assessment is a four or above, then the OSM is designated for repair. Whereas, if the damage assessment is a zero to three, then the OSM is restocked (operation 340).

The damage assessment may also be used to determine the type of repair processing, if any (operation 320). For example, slight damage reflected by a damage score of four or five, may provide a recommended less invasive repair, such as cleaning only or cleaning and use of a lightly abrasive pad. More severe damage, such as reflected by damage scores of five or higher may provide a recommendation of a more invasive repair method, such as cleaning with a more abrasive pad, use of a lapping slurry, and the like. The repair device then proceeds to conduct the repair either automatically or based on user control as recommended by the OCD device (operation 330), after which the OSM may be reassessed by the OCD (operation 310) or identified for restocking (operation 340). If one or more repairs are unsuccessful in reducing the damage level below a threshold that will allow proper reading of data on the device, then the OSM may be identified for discarding (operation 340).

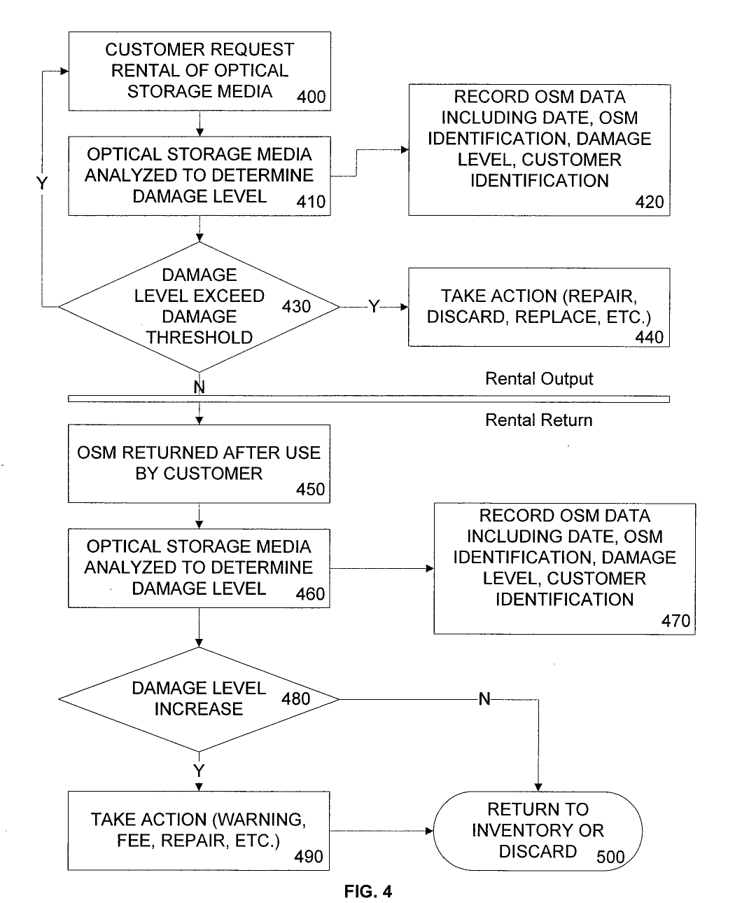

FIG. 4 is a flow diagram illustrating one computerized system OSM inventory processing, both on rental output and/or rental return, for tracking OSM inventory damage, assessing OSM damage charges, and for altering OSM inventory, amongst other uses. These operations may occur at a retail outlet, at a warehouse for shipping and receiving OSMs based on internet or other orders, or at other locations. On the rental output side, a customer requests an OSM for rental, and an employee places the OSM in an OSD device for processing (operation 400). The OCD provides a damage score, which is displayed and also transmitted to the inventory application (operation 410). The inventory application records the date, OSM identification, damage level and customer identification, provided the OSM is in playable condition (operation 420). If the OSM is not in playable condition (operation 430), the OSM is identified for repair or disposal (operation 440), and the customer is provided with a different OSM (operation 400). If the OCD is playable, then the customer receives the OSM.

On return (operation 450), the OSM is again checked for damage and the damage assessment is transmitted to the inventory application and also displayed (operation 460). As with the outgoing side, the inventory application records the date, OSM identification, damage level and customer identification (operation 470). Other parameters may be recorded or updated as well on both the rental and return side. Within the inventory application, the return damage level is compared against the rental damage level (operation 480). If the damage level has increased by some amount X, it is determined whether to warn the customer of their damaging use of the OSM, charge the customer, send the disc for repair, and/or take some other action (operation 490). Such action may be highly customized, and combined as used above, and also used in conjunction with a repair device. If there is no damage change, then the OSM is identified for return to inventory (operation 490).

With respect to damage increase (operation 480), if the initial damage assessment was a two and rose to a three after use by the customer, simply a warning may be communicated to the customer, for example. The inventory application may be configured to update the customer records to indicate the damage and that a warning is proper. At the next rental, a clerk may then provide the warning, an e-mail may be automatically generated and sent to the customer, or the like. In another example, if the damage level increases from two to four, then the customer may receive a charge. The charge may be processed immediately at the next rental, or otherwise. It is possible to first warn the customer and then charge after some number of occurrences. The inventory application in such a customer charge scenario is in communication with the checkout device to process the charge. In this example, the OSM may also be identified for repair. Any number of different scenarios are possible in any particular implementation.

Although the present invention has been described with reference to various embodiments, numerous modifications and variations can be made that are obvious to practitioners in the field and still the result will come within the scope of the invention. No limitation with respect to the specific embodiments disclosed herein is intended or should be inferred.

1. A method for assessing an optical storage media and directing action based on the assessment, the method comprising:
analyzing an optical storage media to provide a damage level indication; and
identifying an action based on the damage level indication.

2. The method of claim 1 wherein the analyzing operation further comprises analyzing an optical storage media using an optical storage media characterization device to provide a damage level indication between 0 and 10.

3. The method of claim 1 wherein the operation of identifying an action comprises identifying a repair action.

4. The method of claim 3 wherein the operation of identifying a repair action comprises identifying a particular repair action based on the damage level indicator's value between 0 and 10.

5. The method of claim 1 further comprising:
comparing the damage level indication to a threshold; and
identifying the action based on a relation between the damage level indication and the threshold.

6. The method of claim 5 wherein the operation of identifying an action comprises identifying a customer consequence based on a relation between the damage level and the threshold.

7. The method of claim 6 wherein the customer consequence is at least one of a warning consequence and a pecuniary consequence.

8. The method of claim 6 wherein the operation of identifying a customer consequence comprises identifying a warning consequence if the damage level exceeds the threshold by a first value and identifying a pecuniary consequence if the damage level exceeds the threshold by a second value.

9. The method of claim 6 wherein the threshold is a customer specific threshold indicative of whether an optical storage media will properly play on a customer device, and the method further comprising updating the customer specific threshold value based on feedback received from the customer.

10. The method of claim 1 wherein the action includes providing for a sales price adjustment for the optical storage media based on the damage level indicator.

11. A method for assessing an optical storage media and directing action based on the assessment, the method comprising:
in conjunction with providing a optical storage media to a customer:
analyzing the optical storage media to provide a damage level indication;
updating a data file to include a customer identification, an optical storage media identifier of the optical storage media provided to the customer and the damage level indication;
in conjunction with return of the optical storage media by the customer:
analyzing the optical storage media to provide a second damage level indication;
updating the data file to include the second damage level indication; and
identifying an action as a function of the first damage level and the second damage level.

12. The method of claim 11 further comprising:
comparing the damage level indicator to a threshold;
providing an indication that the optical storage media will not play properly based on the comparison of the damage level to a threshold; and
providing a playable copy of the optical storage media to the customer, whereafter the operation of updating the data file and other operations are performed in conjunction with the playable copy.

13. The method of claim 11 further comprising:
providing a repair indication based on the damage level indication;
conducting a repair of the optical storage medium; and
reanalyzing the optical storage media to provide a damage level indication.

14. The method of claim 11 wherein the action is at least one of a customer warning, a customer pecuniary consequence, a repair indication, and a replacement indication.

15. The method of claim 11 wherein the identifying operation comprises identifying a pecuniary action if the second damage level exceeds the first damage level by a predetermined amount.

16. The method of claim 11 further comprising:
updating a customer specific threshold value indicative of whether an optical storage media will properly play based on feedback received from the customer.

17. An optical storage media inventory system comprising:
an optical storage media characterization device configured to receive an optical storage media and provide a damage level assessment based on an optical assessment of the optical storage media; and
an inventory application coupled with the optical storage media configured to link a customer with the optical storage media, track the damage level assessment of the optical storage media at a first time and a second time, and provide an action indication as a function of tracking the damage level assessment between the first time and the second time.

18. The optical storage media inventory system of claim 17 further comprising:
a repair device coupled with at least one of the optical storage media characterization device and the inventory application, the repair device configured to perform a repair of the optical storage media based on the damage level assessment.

19. The optical storage media inventory system of claim 17 further comprising:
a checkout device coupled with at least one of the optical storage media characterization device and the inventory application, the checkout device configured to display customer information including an indication of the damage level assessment between the first time and the second time.

20. The optical storage media inventory system of claim 19 wherein the checkout device is configured to process a charge to the customer if the damage level assessment between the first time and the second time meets a threshold.
